(19) United States
(12) Patent Application Publication
(10) Pub. No.: US 2026/0235440 A1
(43) Pub. Date: Aug. 13, 2026

(54) COMBINATION OF TWO LED AND OPEN PORT CALIBRATION

(71) Applicant: TRINAMIX GMBH, Ludwigshafen am Rhein (DE)

(72) Inventors: Celal Mohan OEGUEN, Ludwigshafen am Rhein (DE); Felix SCHMIDT, Ludwigshafen am Rhein (DE); Tobias BAUMGARTNER, Ludwigshafen am Rhein (DE); Michael HANKE, Ludwigshafen am Rhein (DE); Henning ZIMMERMANN, Ludwigshafen am Rhein (DE); Szu-Yu HUANG, Ludwigshafen am Rhein (DE)

(21) Appl. No.: 19/149,780

(22) PCT Filed: Feb. 1, 2024
(86) PCT No.: PCT/EP2024/052472

§ 371 Date: Jul. 21, 2025

(30) Foreign Application Priority Data
Feb. 2, 2023 (EP) 23154645.8

(51) Int. Cl. G01J 3/02; G01J 3/10

(52) U.S. Cl. CPC G01J 3/0297; G01J 3/10

(57) ABSTRACT

Disclosed herein is a method of calibrating a sensing device, including:
I. illuminating at least one detector element via at least one first optical path to obtain at least one first detector signal S₁;
II. illuminating the detector element via at least one second optical path with no sample applied to the sample interface to obtain at least one open port detector signal S_{2;open}; and
III. determining at least one item of operation calibration information by using the first detector signal S₁, the open port detector signal S_{2;open} and at least one item of factory calibration information, where the item of factory calibration information includes a predefined relation between the open port detector signal S_{2;open} and a reference signal of the second optical path.

### TECHNICAL FIELD

The invention relates to a method of calibrating a sensing device, a method of determining at least one calibrated optical property of at least one sample and a sensing device. The invention further relates to computer programs and computer-readable storage media for performing the methods. Such methods and devices can, in general, be used for investigating and/or monitoring purposes in the infrared spectral region, specifically in the near infrared and the mid infrared spectral regions. However, further applications, for example in the visible spectral regions, are also feasible.

### BACKGROUND ART

In general, sensing devices are known which collect optical information from a sample. For example, spectral sensing devices are known to collect information on the spectral light composi-tion from the sample, when irradiating, reflecting and/or absorbing light. In order to allow comparing spectra from multiple spectral sensing devices, the spectral sensing devices have to be calibrated, for example by using known calibration standards.

During operation of such sensing devices, specifically of spectral sensing devices, such as diffuse reflection spectral sensing devices, transmission spectral sensing devices and/or hyperspectral sensing devices, re-calibration of the sensing device may be required from time to time to eliminate any drifts in the optical components and/or in the opto-electronic components. The sensing devices may comprise, inter alia, detectors, electronics, such as analog front-end for digitalization of analog detector signals, and/or power management, which are usually unstable with respect to varying operating conditions, such as varying temperatures and/or humidity. Similarly, radiation sources, for example infrared radiation sources, may degrade with time and/or usage and may also depend on ambient and/or operational conditions. Such drifts can be caused due to various internal and/or external physical changes including, but not limited to: degradation of light sources and/or detectors; temperature drifts of light sources and/or detectors; ambient temperature changes; changes in the device's temperature, for example changes in the temperature of detectors and/or electronics, such as read-out circuits; mechanical extension and/or contraction of mechanical components, such as mechanical housings and/or hold-ers; mechanical extension and/or contraction of optical components, such as bandpass filters, dispersing elements, for example prisms, gratings and the like. If these drifts are not corrected from time to time via calibration, the drift may distort measurement data such that results obtained with the uncalibrated sensing device become inconclusive.

Furthermore, detectors of the sensing device may show hysteresis. This can be compensated by using a temperature stabilization unit. For example, detectors of sensing devices may be cooled by using thermoelectric coolers to reduce the drift in the detector signal due to changing operating temperatures or changing intrinsic detector properties, thus, reducing hysteresis. However, sensing devices with such temperature stabilization units are generally bulky, complex and not cost sensitive.

Thus, typically, known sensing devices may be frequently re-calibrated using known reference standards to eliminate the drifting and/or hysteresis effects. Known calibration processes of spectral sensing devices may involve calibrating the spectral sensing device using a known external calibration standard with regard to the wavelength dependent sensitivity of the detector from time to time before measuring the sample. However, the use of known external calibration standards may be generally not feasible in handheld devices and degrades the user experi-ence, since the user should be involved during the complex calibration process.

Furthermore, even individual detectors of the same type may show deviations with regard to their characteristics, such as temperature coefficient for resistance, responsivity and/or detectiv-ity, due to manufacturing tolerances. Thus, it may not be feasible to use designated “reference” detectors, specifically using the signal from these reference detectors to correct and/or calibrate the rest of the detectors, which measure light coming from the sample. The reference detector may refer to a detector not receiving any radiation from the sample and, thus, its signal may not depend on a presence or absence of any sample.

Known calibration processes may require light and dark calibrations. Different types of calibration measurements may be performed which require either an external calibration standard, such as a predefined reflection target, and/or an empty radiation path in front of the detector to ensure that no reflected radiation reaches the detector. The dark calibration may re-calibrate the “dark current”, “dark noise” and/or “dark resistance”. For performing the dark calibration, no calibration target may be required. Dark calibrations may comprise preventing that detectors are illuminated, either by turning the light sources off and/or by blocking the optical path between the light source and the detectors. The light calibration may comprise calibrating the wave-length dependent sensitivity of the photosensitive detectors. In particular, for reflection spectroscopy, calibration may be performed by employing the external calibration standard with a predefined reflection spectrum to ensure a known and reproducible calibration signal. The external calibration standard may be positioned in a radiation path of the detector similar to spectral measurement of the sample. However, for these calibrations, the user may be responsible to position the external calibration standard and/or removing any objects in the sensing range of the sensing device.

Methods and devices are known to overcome the need for an external calibration standard for the calibration process. For example, calibration processes may comprise a compensation of responsivity drift of a single component, such as of the detector of the sensing device. This may be done in a self-referencing scheme: An environment-sensitive property of the detector may be measured and subsequently used to compensate the detector responsivity. However, compensation of drifts of the sensing device, such as systematic effects originating from the combination of all components in one single sensing device and their dependence on the environment, may be technically challenging by this approach.

As another example, calibration processes may comprise using a built-in reference and a measurement of a reflection of light from the built-in reference in absence of the sample, also referred to as “open port measurement”. This measurement may be used to calculate a fixed factor during factory calibration by comparing the open port measurement to a measurement with an external calibration standard. The calibration is usually based on the assumption that the calibration factor is constant and long-time stable during entire lifecycle of the sensing device. Under this assumption, the open-port measurements may be used to determine the reference value analytically. This calibration scheme may generally require an open-port measurement before and/or after the sample measurement. Each measurement may generate heat by active components, such as lamp drivers, light source, analogue-digital converter or the like. After each measurement, the heat may be dissipated into the sensing device and, thus, may change the temperature of the further components, such as of the detectors. Therefore, generally, ensuring same operating conditions for all components of the sensing device when performing open port measurements and sample measurements may be highly technically challenging. This technical challenge may be overcome by performing open port measurement before and after the sample measurement and approximating the reference signal by fitting the results of before and after measurement linearly. However, this approach may cause further uncertainties as the thermal response of the sensing device can be non-linear. Additionally, drawbacks from this calibration scheme may arise due to the fact that the open port measurements might be disrupted during the usage in the field due to mishandling of the sensing device. For example, a disruption may be caused by a partially covered measurement port with an undefined sample. Such a disruption would further increase the measurement uncertainty of the calibration factor.

As another example, calibration processes may comprise using at least two optical paths, wherein a first optical path may not be affected by the presence or absence of the sample and wherein a detector signal in a second optical path may be dependent on the presence or absence of the sample. The signals in the first and second optical paths may be differentiated by either time or frequency multiplexing. In case of frequency multiplexing, both optical paths are illuminating the detector at the same time but at different modulation frequencies. Thus, in this case, thermal changes effecting the components of the sensing system, such as detectors, light source, read-out electronics or the like, may be identical. The thermal drift may be compensated by normalizing the signal of the detector via the second optical path to the first one. In this approach, the open-port and the reference signal for the second optical path may be dependent on the signal in the first optical path. The calibration typically assumes that the calibration factors are independent of the ambient and operational conditions. However, generally, this assumption may only be valid if the illumination via both optical paths may not change and/or the drift may be identical for both optical paths. A possible realization of this calibration scheme may comprise using two light sources operated at different frequencies for the first optical path and the second optical path, respectively. However, manufacturing tolerances of the light sources may affect the calibration. Similarly, producing other components of the sensing device, such as semiconductor chips, fluorescent coatings of LEDs, filaments of incandescent lamps and/or other light sources, with low manufacturing tolerances may require high effort in production accuracy. Manufacturing tolerances may generally lead to deviations in temperature coefficients of electrical and/or optical properties of the light sources. Deviations may be minimized by using light sources with similar temperature coefficients such that deviations can generally not be ob-served at small temperature changes of few Kelvin. However, at larger temperature differences between the factory calibration and the sample measurement, for example at temperature differ-ence of 10 K or more, manufacturing tolerances may become significant. The assumption of constant calibration factors may, in general, become inaccurate. Additionally, the assumption of constant calibration factors may become inaccurate due to aging effects affecting both light sources differently.

### Problem to be Solved

It is therefore desirable to provide methods and devices, which at least partially address the above-mentioned technical challenges and at least substantially avoid the disadvantages of known methods and devices. In particular, it is an object of the present invention to provide methods and devices to provide a user-friendly and accurate calibration of sensing devices.

### SUMMARY

This problem is addressed by a method of calibrating a sensing device, a method of determining at least one calibrated optical property of at least one sample and a sensing device with the features of the independent claims. This problem is further addressed by computer programs and computer-readable storage media for performing said methods. Advantageous embodiments which might be realized in an isolated fashion or in any arbitrary combinations are listed in the dependent claims as well as throughout the specification.

In a first aspect of the present invention, a method of calibrating a sensing device is disclosed.

The term “sensing device” as used herein is a broad term and is to be given its ordinary and customary meaning to a person of ordinary skill in the art and is not to be limited to a special or customized meaning. The term specifically may refer, without limitation, to an optical device configured for acquiring at least one item of optical information on at least one sample. For example, the sensing device may be an optical device configured for determining and/or detecting and/or sensing the sample, such as a 3D-detector. For example, the sensing device may be an optical device configured for acquiring at least one item of spectral information on the sample. Specifically, the at least one item of spectral information may refer to at least one optical property or optically measurable property which is determined as a function of a wavelength, for one or more different wavelengths. More specifically, the optical property or optically measurable property, as well as the at least one item of spectral information, may relate to at least one property characterizing at least one of a transmission, an absorption, a reflection and an emission of the sample, either by itself or after illumination with external light. The at least one optical property may be determined for one or more wavelengths. The sensing device specifically may form an apparatus which is capable of recording a signal intensity with respect to the corresponding wavelength of a spectrum or a partition thereof, such as a wavelength interval, wherein the signal intensity may, specifically, be provided as an electrical signal which may be used for further evaluation.

The sensing device comprises:
a. at least one detector element configured for generating at least one detector signal in response to an illumination of the detector element by incident light;
b. at least one light source configured for emitting light in at least one optical spectral range;
c. at least one sample interface configured for allowing light from the light source to illuminate at least one sample and configured for allowing light from the sample to propagate, specifically via at least one wavelength-selective element, to the detector element;
d. at least one first optical path, wherein the first optical path is configured for allowing light emitted from the light source to propagate, specifically via the wavelength-selective element, to the detector element without passing the sample interface;
e. at least one second optical path, wherein the second optical path is configured for allowing light emitted from the light source to propagate, specifically via the wavelength-selective element, to the detector element by passing the sample interface at least once.

The term “detector element” as used herein is a broad term and is to be given its ordinary and customary meaning to a person of ordinary skill in the art and is not to be limited to a special or customized meaning. The term specifically may refer, without limitation, to an arbitrary device or combination of devices capable of recording and/or monitoring incident light. The detector element may be responsive to incident light and may be configured for generating an electrical signal indicating an intensity of incident light. For example, the detector element may comprise at least one photosensitive element having at least one photosensitive area configured for recording a photoresponse by generating at least one output signal that depends on an intensity of the incident light impinging on the photosensitive area. The detector element may be sensitive in one or more of a visible spectral range, an ultraviolet spectral range or the infrared spectral range, specifically a near infrared spectral range (NIR). The detector element specifically may be or may comprise at least one optical sensor, e.g. an optical semiconductor sensor. As an example, specifically in case the detector element is sensitive in the infrared spectral range, such as in the near infrared spectral range, the semiconductor sensor may be or may comprise at least one semiconductor sensor comprising at least one material selected from the group consisting of Si, PbS, PbSe, InGaAs, and extended-InGaAs. As an example, the detector element may comprise at least one photodetector such as at least one CCD or CMOS device. The detector element specifically may comprise at least one detector array comprising a plurality of pixelated sensors, wherein each of the pixelated sensors is configured to detect at least a portion of the incident light. Alternatively or additionally, the detector element may comprise a single photosensitive element being responsive in a broad spectral range, such as in one or more of a visible spectral range, an ultraviolet spectral range and an infrared spectral range.

The term “detector signal” as used herein is a broad term and is to be given its ordinary and customary meaning to a person of ordinary skill in the art and is not to be limited to a special or customized meaning. The term specifically may refer, without limitation, to a signal generated by at least one detector, specifically to the electrical signal of the detector element, more specifically to the at least one output signal of the photosensitive element. The at least one detector signal may be an analogue signal and/or a digital signal. The detector element, specifically the individual photosensitive elements, may comprise active pixel sensors which may be adapted to amplify the output signals prior to providing them as detector signals to an internal or external evaluation unit. For this purpose, the detector element, specifically the photosensitive element, may comprise one or more signal processing devices, such as one or more filters and/or ana-logue-digital-converters for processing and/or pre-processing the electronic signals.

The term “illumination” as used herein is a broad term and is to be given its ordinary and customary meaning to a person of ordinary skill in the art and is not to be limited to a special or customized meaning. The term specifically may refer, without limitation, to an amount or an intensity of light impinging a certain area, specifically a photosensitive area of the detector element. The term “light” as used herein is a broad term and is to be given its ordinary and customary meaning to a person of ordinary skill in the art and is not to be limited to a special or customized meaning. The term specifically may refer, without limitation, to a partition of electromagnetic radiation which is, usually, referred to as “optical spectral range” and which comprises one or more of a visible spectral range, an ultraviolet spectral range and an infrared spectral range. The terms “ultraviolet spectral range” or “UV” may, generally, refer to electromagnetic radiation having a wavelength of 1 nm to 380 nm, preferably of 100 nm to 380 nm. The term “visible spectral range” may, generally, refer to a wavelength of 380 nm to 760 nm. The terms “infrared spectral range” or “IR” may, generally, refer to a wavelength of 760 nm to 1000 μm, wherein a wavelength of 760 nm to 3 μm may, usually, be denominated as “near infrared spectral range” or “NIR”, while the wavelength of 3 μ to 15 μm may, usually, be denoted as “mid infrared spectral range” or “MidIR”, and the wave-length of 15 μm to 1000 μm as “far infrared spectral range” or “FIR”.

The sensing device may further comprise at least one wavelength-selective element configured for transferring incident light within at least one selected wavelength range onto the detector element. The term “wavelength-selective element” as used herein is a broad term and is to be given its ordinary and customary meaning to a person of ordinary skill in the art and is not to be limited to a special or customized meaning. The term specifically may refer, without limitation, to an arbitrary element or a combination of elements suitable for one or more of transmitting, reflecting, deflecting or scattering light in a wavelength dependent manner. The wavelength-selective element may specifically be configured for wavelength-dependent transfer by spatially separating incident light having different wavelengths. For example, the wavelength-selective element may be configured for separating incident light into a spectrum of constituent wavelength components and for transmitting wavelength components within the selected wavelength range onto the detector element. The wavelength-dependent transmission, reflections, deflection or scattering of incident light at the wavelength-selective element may result in a spatial separation of incident light. Alternatively or additionally, the wavelength-selective element may be configured for wavelength-dependent transfer by decreasing intensities of light having wavelengths outside the selected wavelength range, such as by using a filter element, specifically a narrow band pass filter. The wavelength-selective element may be selected from the group consisting of: a prism; a grating; a linear variable filter; an optical filter, specifically a narrow band pass filter; a patterned filter; a butchers block filter; a hyperspectral filter; a Fabry-Pérot filter; a tunable microelectromechanical (MEMS) filter, specifically a MEMS Fabry-Pérot filter; an interferometer, specifically a Michelson interferometer; a tunable MEMS Michelson interferometer; a meta-material based grating; a meta-material based filter; an absorption filter; a filter foil. Alternatively or additionally, the wavelength-selective element may be incorporated in the detector element, such as a detector element being sensitive to a particular wavelength range. For example, a detector element being sensitive to a particular wavelength range may provide a combination of the detector element and the wavelength-selective element. The detector element may, as an example, comprise at least one quantum dot sensor and/or at least one organic photodiode.

The term “selected wavelength range” as used herein is a broad term and is to be given its ordinary and customary meaning to a person of ordinary skill in the art and is not to be limited to a special or customized meaning. The term specifically may refer, without limitation, to a wave-length range of light being transmitted, reflected, deflected or scattered by the wavelength-selective element onto the detector element.

The term “light source” as used herein is a broad term and is to be given its ordinary and customary meaning to a person of ordinary skill in the art and is not to be limited to a special or customized meaning. The term specifically may refer, without limitation, to an arbitrary device configured for emitting light in the optical spectral range, i.e. in one or more of the visible spectral range, the infrared spectral range and the ultraviolet spectral range. Specifically, the light source may be configured for emitting light in the infrared spectral range, e.g. light having a wavelength of 760 nm to 100 μm, more specifically light in the near infrared spectral range, e.g. light having a wavelength of 760 nm to 3 μm. The light source may be configured for simultaneously emitting light having different wavelengths, such that the light source may be configured for emitting white light. As an example, the light source may be or may comprise at least one light emitting diode (LED). Other options, however, such as thermal emitters, for example an incandescent lamp or a thermal infrared emitter, or blackbody radiators are also feasible. Alternatively or additionally, the light source may comprise one or more monochromatic light sources, each monochromatic light source being configured for emitting monochromatic light in one or more of the visible spectral range, the infrared spectral range and the ultraviolet spectral range.

The term “sample interface” as used herein is a broad term and is to be given its ordinary and customary meaning to a person of ordinary skill in the art and is not to be limited to a special or customized meaning. The term specifically may refer, without limitation, to a port of the sensing device, specifically of the spectrometer device, through which light in the optical spectral range, such as in at least one partition of the optical spectral range or in the full optical spectral range, may enter the sensing device, specifically for the purpose of the spectral sensing, and/or may leave the sensing device, e.g. for the purpose of illuminating the at least one sample. The sample interface, as an example, may define an optical plane, e.g. a plane either material or imagi-nary, of the sensing device, through which the light from the second optical path, as will be ex-plained in further detail below, may travel to reach the sample and/or through which the reflected light from the sample may travel to reach the detector, e.g. to generate a second detector signal. The sample interface may or may not be constituted by a physical element and/or barrier, such as a transparent element, e.g. a glass or quartz window. The sample interface may also be the sample surface itself or a plane where the sample can be placed or aligned. As an example, the sample interface may be or may comprise at least one element comprising at least one transparent material being at least partially transparent in the optical spectral range, such as in at least one partition of the optical spectral range or in the full optical spectral range. The sample interface may be configured for transmitting light in the optical spectral range. The sample interface may be arranged in an optical path of the sensing device, specifically in the second optical path, to allow light emitted from the light source to illuminate a sample placed in front of the sensing device, specifically in front of the sample interface. The transparent material may, as an example, comprise one or more of a glass material, such as silica, soda lime, borosilicate or the like, and/or a polymeric material, such as polymethylmethacrylate or polystyrene.

The term “sample” as used herein is a broad term and is to be given its ordinary and customary meaning to a person of ordinary skill in the art and is not to be limited to a special or customized meaning. The term specifically may refer, without limitation, to an arbitrary object or element, chosen from a living object or a non-living object, and having at least one optical property, the determination of the optical property, preferably, being of interest to a user when using the sensing device. The sample may be suitable for interfacing with the sensing device, specifically with the sample interface.

As outlined above, the sensing device comprises the at least one first optical path and the at least one second optical path. The term “optical path” as used herein is a broad term and is to be given its ordinary and customary meaning to a person of ordinary skill in the art and is not to be limited to a special or customized meaning. The term specifically may refer, without limitation, to a trajectory of light in the sensing device. The optical path of light in the sensing device may be affected by reflection, refraction, dispersion and/or absorption at one or more optical elements, such as lenses, prisms, mirrors, gratings or the like, comprised by the sensing device. The terms “first” and “second”, as generally used herein, are used for nomenclature, only, without implying any ranking or numbering.

The term “first optical path” as used herein is a broad term and is to be given its ordinary and customary meaning to a person of ordinary skill in the art and is not to be limited to a special or customized meaning. The term specifically may refer, without limitation, to an optical path without sample interaction. Specifically, a detector signal obtained via the first optical path may be unaffected from a presence and/or an absence of the sample at the sensing device. For example, a detector signal obtained via the first optical path having the sample applied to the sensing device may be equal to a detector signal obtained via the first optical path having no sample applied to the sensing device, specifically assuming constant environmental conditions. In particular, as outlined above, the first optical path is configured for allowing light emitted from the light source to propagate, specifically via the wavelength-selective element, to the detector element without passing the sample interface, specifically without being reflected at the sample. For example, via the first optical path, light emitted from the light source may be passed to the wave-length-selective element and subsequently to the detector element without interacting with the sample. The first optical path may be arranged completely in the sensing device, such as within a housing of the sensing device. Light following the first optical path may be emitted by the light source and may be directly or indirectly, such as by reflection, refraction and/or dispersion, guided to the detector element, specifically guided to the wavelength-selective element and subsequently to the detector element. As an example, the first optical path may comprise a fiber coupled optical path transferring light from the light source to the detector element. The detector element may be configured for generating at least one detector signal in response to an illumination by incident light via the first optical path.

The term “second optical path” as used herein is a broad term and is to be given its ordinary and customary meaning to a person of ordinary skill in the art and is not to be limited to a special or customized meaning. The term specifically may refer, without limitation, to an optical path with sample interaction. Specifically, a detector signal obtained via the second optical path may be affected from a presence and/or an absence of the sample at the sensing device. For example, a detector signal obtained via the second optical path having the sample applied to the sensing device may be different from a detector signal obtained via the second optical path having no sample applied to the sensing device, specifically irrespective of constant environmental conditions. In particular, the second optical path is configured for allowing light emitted from the light source to propagate, specifically via the wavelength-selective element, to the detector element by passing the sample interface at least once. For example, the second optical path may allow light emitted from the light source to propagate to the sample interface and, subsequently, via the wavelength-selective element to the detector element. Via the second optical path, light emitted from the light source may be guided directly or indirectly, such as by reflection, refraction and/or dispersion, to the sample interface. The second optical path may be partially arranged outside the sensing device, such as outside a housing of the sensing device. Specifically, light in the second optical path may leave the sensing device, in particular a housing of the sensing device, at the sample interface to illuminate the sample arranged outside the sensing device. The second optical path may be configured for coupling light reflected at the sample back into the sensing device. Light reflected at the sample interface may be guided directly or indirectly, such as by reflection, refraction and/or dispersion, to the detector element, specifically to the wavelength-selective element and subsequently to the detector element. The reflection at the sample interface may comprise a diffuse reflection. Specifically, light in the second optical path illuminating the wavelength-selective element and subsequently the detector element may be diffusively reflected light. The detector element may be configured for generating at least one detector signal in response to an illumination by incident light via the second optical path.

One or more of the first optical path and the second optical path may comprise at least one built-in reference target. The built-in reference target may cover completely the first optical path for determining the first detector signal, such as by having a first light source in the first optical path, wherein the second optical path may be covered only partially with the built-in reference target. Thus, a part of the light from the light source in the second optical path may go through the sample interface, wherein another part of the light may be reflected back to the detector element to determine the open port detector signal. Alternatively or additionally, the built-in reference target may be split into two built-in reference targets in the first and second optical path, respectively.

The method is a method of calibrating the sensing device. The term “calibrating”, also referred to as “calibration”, as used herein is a broad term and is to be given its ordinary and customary meaning to a person of ordinary skill in the art and is not to be limited to a special or customized meaning. The term specifically may refer, without limitation, to a process of at least one of determining, correcting, adjusting and compensating measurement inaccuracies at the sensing device. The calibration may comprise determining at least one item of calibration information. The item of calibration information may comprise at least one item of information on a result of the calibration, such as a calibration function, a calibration factor, a calibration matrix or the like. The item of calibration information may be used for transforming one or more measured values into one or more calibrated or “true” values. Measurement inaccuracies may, as an example, arise from uncertainties in wavelength determination and/or from intrinsic and/or extrinsic interferences on measurement signals of the sensing device. The calibration of the sensing device may comprise at least one of a wavelength calibration, a stray light calibration and a dark current calibration. The calibration may comprise at least one two-step process, wherein, in a first step, information on a deviation of a measurement signal of the sensing device from a known standard is determined, wherein, in a second step, this information is used for correcting and/or adjusting the measurement signal of the sensing device in order to reduce, minimize and/or eliminate the deviation. The calibration may comprise applying the at least one item of calibration information, for example to a measurement signal and/or to a measurement spectrum of the sensing device. A calibration of the sensing device may improve and/or maintain accuracy of measurements performed with the calibrated sensing device.

The method comprises the following steps which, as an example, may be performed in the given order. It shall be noted, however, that a different order is also possible. Further, it is also possible to perform one, more than one or even all of the method steps once or repeatedly. Further, it is possible to perform two or more of the method steps simultaneously or in a timely overlapping fashion. The method may comprise further method steps which are not listed.

The method comprises:
I. illuminating the detector element via the at least one first optical path to obtain at least one first detector signal S₁;
II. illuminating the detector element via the at least one second optical path with no sample applied to the sample interface to obtain at least one open port detector signal S_{2;open}; and
III. determining at least one item of operation calibration information by using the first detector signal S₁, the open port detector signal S_{2;open} and at least one item of factory calibration information, wherein the item of factory calibration information comprises a predefined relation between the open port detector signal S_{2;open} and a reference signal of the second optical path.

The term “illuminating” as used herein is a broad term and is to be given its ordinary and customary meaning to a person of ordinary skill in the art and is not to be limited to a special or customized meaning. The term specifically may refer, without limitation, to a process of at least one of providing, passing and guiding light onto a device or element to be illuminated. Specifically, the detector element may be illuminated with light via at least one of the first and the second optical path, wherein light emitted from the light source of the sensing device may be guided onto the detector element. The illuminating may comprise directly illuminating the detector element, such as directly guiding the light emitted from the light source to the detector element without sample interaction, and/or indirectly illuminating the detector element, such as guiding the light emitted from the light source to the detector element with intermediate sample interaction. The illuminating of the detector element may comprise light reaching a photosensitive area of the detector element and, thus, may cause the detector element to generate the detector signal, for example an electronic signal indicative of the illumination of the detector element. The illuminating of the detector element may specifically comprise guiding light emitted from the light source via at least one of the first and the second optical path to the detector element.

The term “first detector signal” as used herein is a broad term and is to be given its ordinary and customary meaning to a person of ordinary skill in the art and is not to be limited to a special or customized meaning. The term specifically may refer, without limitation, to a detector signal obtained by illuminating the detector element via the first optical path. The first detector signal may be a detector signal without interaction with one or more of the sample interface and the sample. As outlined above, the term “first”, as also used in the context of the detector signal, is used for the purpose of nomenclature rather than for the purpose of providing a ranking. Further, since the term is used for the purpose of nomenclature, only, the term does not imply the neces-sity of the presence of further elements of similar kind, such as in the present case the presence of further detector signals. The term “open port detector signal” as used herein is a broad term and is to be given its ordinary and customary meaning to a person of ordinary skill in the art and is not to be limited to a special or customized meaning. The term specifically may refer, without limitation, to a detector signal obtained by illuminating the detector element via the second optical path without having the sample applied to the sample interface.

The term “item of operation calibration information” as used herein is a broad term and is to be given its ordinary and customary meaning to a person of ordinary skill in the art and is not to be limited to a special or customized meaning. The term specifically may refer, without limitation, to an item of calibration information being at least partially based on the first and second detector signals of the sensing device. The item of operation calibration information may be determined during operation of the sensing device, e.g. during a calibration procedure and/or during a measurement procedure. For example, the item of operation calibration information may be determined during operation of the sensing device in a calibration procedure and/or during a measurement procedure at the customers side. The item of operation calibration information may be a function of one or more of the first detector signal S₁, the open port detector signal S_{2;open} and the item of factory calibration information. The item of operation calibration information may depend on varying operating conditions, such as varying temperatures and/or humidity, and/or degradation of the sensing device, such as degradation of the light source and/or the detector element. The item of operation calibration information may be configured for accounting for drifting effects due to varying operating conditions and/or degradation of the sensing device, specifically for providing compensation of the detector signal for such drifting effects.

The term “item of factory calibration information” as used herein is a broad term and is to be given its ordinary and customary meaning to a person of ordinary skill in the art and is not to be limited to a special or customized meaning. The term specifically may refer, without limitation, to a predefined and/or predetermined item of calibration information being determined in at least one factory calibration process. The factory calibration process may, as an example, comprise determining the item of factory calibration information using at least one reference sample, such as at least one sample with known optical properties, for example known reflectance and/or absorbance. The factory calibration process may be performed at the manufacturing side of the sensing device. The factory calibration process may comprise determining the item of calibration information using a plurality of sensing device, such as determining the item of calibration information for a batch of sensing devices. The item of factory calibration may be a pre-determined item of calibration information. For example, the item of factory calibration information may be determined prior to step I. of the method of calibrating the sensing device. The item of factory calibration information may be assumed to be constant over the lifespan of the sensing device.

As outlined above, the item of factory calibration information comprises the predefined relation between the open port detector signal S_{2;open} and the reference signal of the second optical path. For example, the predefined relation may be given by a mathematical function ƒ:

$${S}_{2 ; ref} = f ( {S}_{2 ; open} ) , \qquad ( Eq . 1 )$$

wherein S_{2;ref} denotes the reference signal of the second optical path.

The mathematic function ƒ may comprise at least one function selected from the group consisting of: a linear function; a polynomial function, specifically a polynomial function of degree n=2 or higher; a power function; an exponential function; a power law; a sum of two or more of the previous functions. For example, the predefined relation may be given hv

$${S}_{2 ; ref} = a * {S}_{2 ; open} , \qquad ( Eq . 2 )$$

wherein a is a constant, a ∈ [symbol] .

The predefined relation may be determined prior to step I., specifically in a factory calibration of the sensing device being performed prior to step I.

The first relation may be given by a mathematical function g:

$${S}_{2 ; ref} = g ( {S}_{1} ) , \qquad ( Eq . 3 )$$

wherein S_{2;ref} denotes the reference signal of the second optical path.

The mathematic function g may comprise at least one function selected from the group consisting of: a linear function; a polynomial function, specifically a polynomial function of degree n=2 or higher; a power function; an exponential function; a power law; a sum of two or more of the previous functions. For example, the first relation may be given by:

$${S}_{2 ; ref} = b * {S}_{1} , \qquad ( Eq . 4 )$$

wherein b is a constant, b∈ [symbol] .

The method of calibrating the sensing device may comprise in step III, determining the first relation, specifically determining factor b. The determining of the first relation may comprise using the item of factory calibration information, specifically the predefined relation between the open port detector signal S_{2;open} and the reference signal of the second optical path. For example, by using the item of factory calibration information, specifically the predefined relation, such as exemplarily given by equation 2, it may be possible to determine the first relation, specifically determining factor b, using the open port detector signal S_{2;open}.

The item of operation calibration information may further comprise information on a second relation between the first detector signal S₁ and the open port detector signal S_{2;open}. For example, the second relation may be given by a mathematical function h:

$${S}_{2 ; open} = h ( {S}_{1} ) . \qquad ( Eq . 5 )$$

The mathematic function h may comprise at least one function selected from the group consisting of: a linear function; a polynomial function, specifically a polynomial function of degree n=2 or higher; a power function; an exponential function; a power law; a sum of two or more of the previous functions. For example, the second relation may be given by:

$${S}_{2 ; open} = c * {S}_{1} , \qquad ( Eq . 6 )$$

wherein c is a constant, c∈ [symbol] .

The method of calibrating the sensing device may comprise in step III. determining the second relation, specifically determining factor c.

In the method of calibrating the sensing device, steps I. and II. may be performed using at least one multiplexing method selected from the group consisting of: a time multiplexing method; a frequency multiplexing method. For example, steps I. and II. may be performed using a frequency multiplexing method. The sensing device may comprise two light sources, wherein a first light source arranged in the first optical path may be operated with frequency ƒ₁ and a second light source arranged in the second light path may be operated with a frequency ƒ₂, wherein ƒ₁≠ƒ₂. For example, steps I. and II. may be performed using a time multiplexing method. The light source of the sensing device may be operated sequentially to illuminate the first and the second optical path sequentially.

In a further aspect of the present invention, a method of determining at least one calibrated optical property of at least one sample is disclosed. For definitions of terms and possible embodiments, reference is made to the description of the method of calibrating a sensing device as outlined above.

The term “optical property” as used herein is a broad term and is to be given its ordinary and customary meaning to a person of ordinary skill in the art and is not to be limited to a special or customized meaning. The term specifically may refer, without limitation, to at least one item of information of the sample describing an interaction of the sample with light. The optical property may be probed by determining an interaction of the sample with light. The term “calibrated optical property” as used herein is a broad term and is to be given its ordinary and customary meaning to a person of ordinary skill in the art and is not to be limited to a special or customized meaning. The term specifically may refer, without limitation, to an optical property being trans-formed by using the at least one item of operation calibration information. Specifically, the calibrated optical property may be corrected, adjusted and/or compensated for one or more measurement inaccuracies at the sensing device, such as measurement inaccuracies arising from uncertainties in wavelength determination and/or from intrinsic and/or extrinsic interferences on measurement signals of the sensing device. The calibrated optical property, as an example, may be an optical property of the sample which has been corrected, adjusted and/or compensated for drift effects on optical parts of the sensing device, such as drift effects due to temperature and/or humidity variation at the detector element, degradation effects of the light source and/or other optical parts of the sensing device. The calibrated optical property may be the result of the method of determining at least one calibrated optical property of at least one sample, wherein, specifically, the calibration may be performed at least partially simultaneously, such as in a partially timely overlapping fashion, and/or sequentially to a presence of the sample at the sensing device. The calibrated optical property of the sample may comprise one or more of an optical absorbance and an optical reflectivity of the sample.

The method comprises the following steps which, as an example, may be performed in the given order. It shall be noted, however, that a different order is also possible. Further, it is also possible to perform one, more than one or even all of the method steps once or repeatedly. Further, it is possible to perform two or more of the method steps simultaneously or in a timely overlapping fashion. The method may comprise further method steps which are not listed.

The method comprises:
i. providing the sensing device according to the present invention, such as according to an embodiment of the sensing device defined with respect to the method of calibrating a sensing device outlined above and/or according to any other embodiment disclosed in further detail below;
ii providing the at least one sample, specifically providing the at least one sample to the sample interface;
iii. illuminating the detector element via the at least one first optical path to obtain at least one first detector signal S₁;
iv. illuminating the detector element via the at least one second optical path to obtain at least one second detector signal S₂; and
v. determining the at least one calibrated optical property of the sample by using the first detector signal S₁, the second detector signal S₂ and the at least one item of operation calibration information determined by using the method of calibrating a sensing device according to the present invention, such as according to any one of the embodiments described above and/or according to any other embodiment disclosed in further detail below.

The sensing device used for the method of determining at least one calibrated optical property of at least one sample may be embodied identical or similar to the sensing device used for the method of calibrating a sensing device according to the present invention, such as according to any one of the embodiments described above. In fact, one and the same sensing device may be used for both methods. However, other embodiments of the sensing devices provided in step i. are also feasible, for example according to any one of the embodiments of the sensing device disclosed in further detail below.

As outlined above, the item of operation calibration information may comprise information on the first relation between the first detector signal S₁ and a reference signal of the second optical path S_{2;ref}. For example, the first relation may be given by:

$${S}_{2 ; ref} = b * {S}_{1} , \qquad ( Eq . 7 )$$

wherein b is a constant, b ∈ [symbol] .

The item of operation calibration information may further comprise information on the second relation between the first detector signal S₁ and an open port detector signal S_{2;open}. For example, the second relation may be given by:

$${S}_{2 ; open} = c * {S}_{1} , \qquad ( Eq . 8 )$$

wherein c is a constant, c ∈ [symbol] .

For example, the calibrated optical property of the sample may be an optical reflectivity of the sample Rₛₐₘₚₗₑ. In general, the reflectance of the sample may be determined according to:

$${R}_{Sample} = \frac{{S}_{2} - {S}_{2 ; open}}{{s}_{2 ; ref}} . \qquad ( Eq . 9 )$$

Using equations 7 and 8, the optical reflectivity of the sample may be:

$${R}_{Sample} = \frac{{S}_{2} - c * {S}_{1}}{b * {S}_{1}} . \qquad ( Eq . 10 )$$

Further, the method of determining at least one calibrated optical property of at least one sample may comprise re-determining the item of operation calibration information, specifically re-determining one or more of the information on the first and the second relation, respectively, more specifically re-determining one or more of factors a and b.

The sensing device may further comprise at least one monitoring device for monitoring at least one operation condition of the sensing device, specifically for monitoring one or more of an ambient temperature, a temperature of one or more of the sensing device's components, for example light source and/or detector element, an ambient humidity or the like. The item of operation calibration information may be re-determined in case the monitored operation condition deviates from a nominal value by more than a predefined threshold. For example, the monitored operation condition is a temperature of the sensing device. The item of operation calibration information may be re-determined in case the temperature deviates by more than the predefined threshold, for example by more than 10 K, from a temperature value of a previous determination of the item of operation calibration information. In this case, the nominal value may be a temperature value of the previous determination. The re-determining of the item of operation calibration information may comprise performing the method of calibrating a sensing device according to the present invention, such as according to any one of the embodiments disclosed above and/or according to any one of the embodiments disclosed in further detail below. Alternatively or additionally, the monitored operation condition is an ambient temperature of the sensing device.

In the method of determining at least one calibrated optical property of at least one sample, steps iii, and iv. may be performed using at least one multiplexing method selected from the group consisting of: a time multiplexing method; a frequency multiplexing method. Exemplary embodiments of such multiplexing methods are described with reference to the method of calibrating a sensing device. Thus, for a description of the multiplexing methods, reference is made to the description of the method of calibrating a sensing device.

In a further aspect of the present invention, a sensing device is disclosed. For definitions of terms and possible embodiments, reference is made to the description of the method of calibrating a sensing device as outlined above.

The sensing device comprises:
a. at least one detector element configured for generating at least one detector signal in response to an illumination of the detector element by incident light;
b. at least one light source configured for emitting light in at least one optical spectral range;
C. at least one sample interface configured for allowing light from the light source to illuminate at least one sample and configured for allowing light from the sample to propagate, specifically via at least one wavelength-selective element, to the detector element;
d. at least one first optical path, wherein the first optical path is configured for allowing light emitted from the light source to propagate, specifically via the wavelength-selective element, to the detector element without passing the sample interface;
e. at least one second optical path, wherein the second optical path is configured for allowing light emitted from the light source to propagate, specifically via the wavelength-selective element, to the detector element by passing the sample interface at least once; and
f. at least one evaluation unit configured for determining at least one calibrated optical property of the sample by using the method of determining at least one calibrated optical property of at least one sample according to the present invention, such as according to any one of the embodiments disclosed above and/or according to any one of the embodiments disclosed in further detail below.

The term “evaluation unit” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. The evaluation unit may comprise one or more processors. In particular, the evaluation unit may be configured for processing basic instructions that drive the computer or system. As an example, the evaluation unit may comprise at least one arithmetic logic unit (ALU), at least one floating-point unit (FPU), such as a math co-processor or a numeric co-processor, a plurality of registers, specifically registers configured for supplying operands to the ALU and storing results of operations, and a memory, such as an L1 and L2 cache memory. In particular, the evaluation unit may be a multi-core processor. Specifically, the evaluation unit may be or may comprise a central processing unit (CPU). Additionally or alternatively, the evaluation unit may be or may comprise a micropro-cessor, thus specifically the evaluation unit's elements may be contained in one single integrated circuitry (IC) chip. Additionally or alternatively, the evaluation unit may be or may comprise one or more application-specific integrated circuits (ASICs) and/or one or more field-pro-grammable gate arrays (FPGAs) and/or one or more tensor processing unit (TPU) and/or one or more chip, such as a dedicated machine learning optimized chip, or the like.

The evaluation unit may, for example by software programming, be configured for determining the calibrated optical property of the sample by performing step v. of the method of determining at least one calibrated optical property of at least one sample according to the present inventions. Further, the evaluation unit may, for example by software programming, be configured for determining the at least one item of operation calibration information by using the method of calibrating a sensing device according to the present invention, such as according to any one of the embodiments disclosed above and/or according to any one of the embodiments disclosed in further detail below. Specifically, the evaluation unit may be configured for determining the item of calibration information by performing step III. of the method of calibrating a sensing device according to the present inventions.

The sensing device may further comprise at least one wavelength-selective element configured for transferring incident light within at least one selected wavelength range onto the detector element. For possible embodiments of the wavelength-selective element, reference is made to the description of the method above.

The sensing device may further comprise at least one monitoring device for monitoring at least one operation condition of the sensing device. The term “sensing device” as used herein is a broad term and is to be given its ordinary and customary meaning to a person of ordinary skill in the art and is not to be limited to a special or customized meaning. The term specifically may refer, without limitation, to an arbitrary element configured for one or more of detecting, measuring or monitoring at least one measurement variable or measurement property. Specifically, the monitoring device may be capable of generating at least one signal, such as a measurement signal, e.g. an electrical signal, which is a qualitative or quantitative indicator of the measurement variable and/or measurement property. For example, the monitoring device may be configured for monitoring an ambient temperature of the sensing device. For example, the monitoring device may be configured for monitoring an ambient humidity of the sensing device. For example, the monitoring device may be configured for monitoring both the ambient temperature and the ambient humidity of the sensing device.

In a further aspect of the present invention, a computer program for calibrating a sensing device is disclosed, comprising instructions which, when the program is executed by a computer or computer network, for example by the evaluation unit of the sensing device, cause the computer or computer network to perform at least step III. of the method of calibrating a sensing device according to the present invention, such as according to any one of the embodiments disclosed above and/or according to any one of the embodiments disclosed in further detail below.

The computer program may further comprise instructions which, when executed by the com-puter or computer network, for example by the evaluation unit of the sensing device, cause the computer or computer network to control performing of steps I. and II. of the method of calibrating a sensing device according to the present invention, such as according to any one of the embodiments disclosed above and/or according to any one of the embodiments disclosed in further detail below.

Similarly, a computer-readable storage medium, specifically a non-transient computer-readable storage medium, is disclosed, comprising instructions which, when the instructions are executed by a computer or computer network, for example by the evaluation unit of the sensing device, cause the computer or computer network to perform at least step III. of the method of calibrating a sensing device according to the present invention, such as according to any one of the embodiments disclosed above and/or according to any one of the embodiments disclosed in further detail below.

As used herein, the term “computer-readable storage medium” specifically may refer to non-transitory data storage means, such as a hardware storage medium having stored thereon com-puter-executable instructions. The computer-readable data carrier or storage medium specifically may be or may comprise a storage medium such as a random-access memory (RAM) and/or a read-only memory (ROM).

The computer-readable storage medium may further comprise instructions which, when the instructions are executed by the computer or computer network, for example by the evaluation unit of the sensing device, cause the computer or computer network to control performing of steps I. and II. of the method of calibrating a sensing device according to the present invention, such as according to any one of the embodiments disclosed above and/or according to any one of the embodiments disclosed in further detail below.

In a further aspect of the present invention, a computer program for determining at least one calibrated optical property of at least one sample is disclosed, comprising instructions which, when the program is executed by a computer or computer network, for example by the evaluation unit of the sensing device, cause the computer or computer network to perform at least step v. of the method of determining at least one calibrated optical property of at least one sample according to the present invention, such as according to any one of the embodiments disclosed above and/or according to any one of the embodiments disclosed in further detail below.

The computer program may further comprise instructions which, when the program is executed by a computer or computer network, for example by the evaluation unit of the sensing device, cause the computer or computer network to control performing steps iii, and iv. of the method of determining at least one calibrated optical property of at least one sample according to the present invention, such as according to any one of the embodiments disclosed above and/or according to any one of the embodiments disclosed in further detail below.

The computer program may further comprise instructions which, when the program is executed by a computer or computer network, for example by the evaluation unit of the sensing device, cause the computer or computer network to prompt a user to perform steps i. and ii. of the method of determining at least one calibrated optical property of at least one sample according to the present invention, such as according to any one of the embodiments disclosed above and/or according to any one of the embodiments disclosed in further detail below.

Similarly, a computer-readable storage medium, specifically a non-transient computer-readable storage medium, is disclosed, comprising instructions which, when the instructions are executed by a computer or computer network, for example by the evaluation unit of the sensing device, cause the computer or computer network to perform at least step v. of the method of determining at least one calibrated optical property of at least one sample according to the present invention, such as according to any one of the embodiments disclosed above and/or according to any one of the embodiments disclosed in further detail below.

The computer-readable storage medium may further comprise instructions which, when the instructions are executed by a computer or computer network, for example by the evaluation unit of the sensing device, cause the computer or computer network to control performing steps iii. and iv. of the method of determining at least one calibrated optical property of at least one sample according to the present invention, such as according to any one of the embodiments disclosed above and/or according to any one of the embodiments disclosed in further detail below.

The computer-readable storage medium according may further comprise instructions which, when the instructions are executed by a computer or computer network, for example by the evaluation unit of the sensing device, cause the computer or computer network to prompt a user to perform steps i. and ii. of the method of determining at least one calibrated optical property of at least one sample according to the present invention, such as according to any one of the embodiments disclosed above and/or according to any one of the embodiments disclosed in further detail below.

Further disclosed and proposed herein are computer programs including computer-executable instructions for performing the methods according to the present invention in one or more of the embodiments enclosed herein when the programs are executed on a computer or computer network. Specifically, the computer programs may be stored on computer-readable data carriers and/or on computer-readable storage media.

Thus, specifically, one, more than one or even all of method steps I. to III. and/or one, more than one or even all of method steps i. to v. as indicated above may be performed, controlled and/or assisted by using a computer or a computer network, preferably by using a computer program.

Further disclosed and proposed herein are computer program products having program code means, in order to perform the methods according to the present invention in one or more of the embodiments enclosed herein when the programs are executed on a computer or computer network. Specifically, the program code means may be stored on computer-readable data carriers and/or on computer-readable storage media.

Further disclosed and proposed herein are data carriers having a data structure stored thereon, which, after loading into a computer or computer network, such as into a working memory or main memory of the computer or computer network, may execute the methods according to one or more of the embodiments disclosed herein.

Further disclosed and proposed herein are computer program products with program code means stored on machine-readable carriers, in order to perform the methods according to one or more of the embodiments disclosed herein, when the program are executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network.

Finally, disclosed and proposed herein are modulated data signals which contains instructions readable by a computer system or computer network, for performing the methods according to one or more of the embodiments disclosed herein.

Referring to the computer-implemented aspects of the invention, one or more of the method steps I. to III. and/or method steps i. to v. or even all of the method steps of the methods according to one or more of the embodiments disclosed herein may be performed by using a com-puter or computer network. Thus, generally, any of the method steps including provision and/or manipulation of data may be performed by using a computer or computer network. Generally, these method steps may include any of the method steps, typically except for method steps re-quiring manual work, such as providing the samples and/or certain aspects of performing the actual measurements.

Specifically, further disclosed herein are:
a computer or computer network comprising at least one processor, wherein the processor is adapted to perform one or more of the methods according to one of the embodiments described in this description, a computer loadable data structure that is adapted to perform one or more of the methods according to one of the embodiments described in this description while the data structure is being executed on a computer,
a computer program, wherein the computer program is adapted to perform one or more of the methods according to one of the embodiments described in this description while the program is being executed on a computer,
a computer program comprising program means for performing one or more of the methods according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform one or more of the methods according to one of the embodiments described in this description after having been loaded into a main and/or working storage of a computer or of a computer network, and
a computer program product having program code means, wherein the program code means can be stored or are stored on a storage medium, for performing one or more of the methods according to one of the embodiments described in this description, if the program code means are executed on a computer or on a computer network.

The methods, the sensing device and the computer programs and computer-readable storage media according to the present invention may provide a large number of advantages over known methods and devices. The methods according to the present invention, specifically the method of calibrating a sensing device, may comprise a combination of above-discussed calibration schemes, i.e. the combination of a built-in reference target and at least two separated optical paths, for example realized by using two light sources modulated at different frequencies. This solution may assume only one item of factory calibration information, for example one constant calibration factor a, depending only on the mechanical features of the sensing device, such the housing and/or the built-in reference target of the sensing device, wherein the latter may not degrade significantly over its lifespan as it is merely a passive optical component. Thus, depending on the ambient and the operational conditions, the user may be able to perform an open-port calibration allowing the re-calculation of the item of operation calibration information, for example of the factors b and c.

The sensing device may be configured, such as by comprising the monitoring device, for monitoring ambient and/or operational conditions, such as temperature and/or humidity, and, option-ally, for saving the monitored ambient and/or operational conditions during user calibration. If, for example, the temperature changes less than the predefined threshold, for example less than 3 K, specifically less than 2 K, the re-calculated item of operation calibration information may be used for further measurement of the sample. The monitoring device may be configured for informing the user in case the deviation of the temperature exceeds the predefined threshold limit, for in case of temperature deviation by more than 10 K, and for informing and/or causing the re-calibration.

The methods according to the present invention, specifically the method of calibrating a sensing device, may combine advantages and mitigates disadvantages of both previously used calibration methods. From the open port calibration, the method of calibrating a sensing device may use an open port calibration based on only one light source. Thus, aging and/or environmental influences, such as temperature dependence, can be calibrated since the item of operation calibration information solely depends on the respective optical path. Additionally, reliable calibration of the light source long term may be achieved by the built-in reference target. Further, the calibration via the first and the second optical path may allow calibrating the response of the sensing device simultaneously to the sample measurement. This may mitigate the disadvantage of the open-port calibration.

The proposed solution may further avoid the need of a temperature stabilization unit as well as the need for an external calibration standard with user involvement allowing the sensing device to be miniaturized to fit e.g. into mobile devices, such as smartphone or any handheld devices, allowing the ease of operation.

Further, the built-in reference target may avoid the disadvantages of an external calibration targets as defined by the state-of-the-art, specifically deteriorating over time as it is subject to environmental influences, for example an external calibration standard used in muddy environment or the like. The built-in reference target may be shielded from such environmental influences.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, nonwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

Summarizing and without excluding further possible embodiments, the following embodiments may be envisaged:

Embodiment 1: A method of calibrating a sensing device, the sensing device comprising:
a. at least one detector element configured for generating at least one detector signal in response to an illumination of the detector element by incident light;
b. at least one light source configured for emitting light in at least one optical spectral range;
c. at least one sample interface configured for allowing light from the light source to illuminate at least one sample and configured for allowing light from the sample to propagate, specifically via at least one wavelength-selective element, to the detector element;
d. at least one first optical path, wherein the first optical path is configured for allowing light emitted from the light source to propagate, specifically via the wavelength-selective element, to the detector element without passing the sample interface;
e. at least one second optical path, wherein the second optical path is configured for allowing light emitted from the light source to propagate, specifically via the wave-length-selective element, to the detector element by passing the sample interface at least once;
the method comprising:
I. illuminating the detector element via the at least one first optical path to obtain at least one first detector signal S₁;
II. illuminating the detector element via the at least one second optical path with no sample applied to the sample interface to obtain at least one open port detector signal S_{2;open}; and
III. determining at least one item of operation calibration information by using the first detector signal S₁, the open port detector signal S_{2;open} and at least one item of factory calibration information, wherein the item of factory calibration information comprises a predefined relation between the open port detector signal S_{2;open} and a reference signal of the second optical path.

Embodiment 2: The method according to the preceding embodiment, wherein the sensing device further comprises at least one wavelength-selective element configured for transferring incident light within at least one selected wavelength range onto the detector element.

Embodiment 3: The method according to any one of the preceding embodiments, wherein the predefined relation is given by a mathematical function ƒ:

$${S}_{2 ; ref} = f ( {S}_{2 ; open} ) ,$$

wherein S_{2;ref} denotes the reference signal of the second optical path.

Embodiment 4: The method according to the preceding embodiment, wherein the mathematic function ƒ comprises at least one function selected from the group consisting of: a linear function; a polynomial function, specifically a polynomial function of degree n=2 or higher; a power function; an exponential function; a power law; a sum of two or more of the previous functions.

Embodiment 5: The method according to any one of the two preceding embodiments, wherein the predefined relation is given by:

$${S}_{2 ; ref} = a * {S}_{2 ; open} ,$$

wherein a is a constant, a ∈ [symbol] .

Embodiment 6: The method according to any one of the preceding embodiments, wherein the predefined relation is determined prior to step I., specifically in a factory calibration of the sensing device being performed prior to step I.

Embodiment 7: The method according to any one of the preceding embodiments, wherein the item of operation calibration information comprises information on a first relation between the first detector signal S₁ and the reference signal of the second optical path.

Embodiment 8: The method according to the preceding embodiment, wherein the first relation is given by a mathematical function g:

$${S}_{2 ; ref} = g ( {S}_{1} ) ,$$

wherein S_{2;ref} denotes the reference signal of the second optical path.

Embodiment 9: The method according to the preceding embodiment, wherein the mathematic function g comprises at least one function selected from the group consisting of: a linear function; a polynomial function, specifically a polynomial function of degree n=2 or higher; a power function; an exponential function; a power law; a sum of two or more of the previous functions.

Embodiment 10: The method according to any one of the three preceding embodiments, wherein the first relation is given by:

$${S}_{2 ; ref} = b * {S}_{1} ,$$

wherein b is a constant, b ∈ [symbol] .

Embodiment 11: The method according to any one of the four preceding embodiments, wherein the method comprises in step III. determining the first relation, specifically determining factor b, wherein the determining of the first relation comprises using the item of factory calibration information, specifically the predefined relation between the open port detector signal S_{2;open} and the reference signal of the second optical path.

Embodiment 12: The method according to any one of the preceding embodiments, wherein the item of operation calibration information comprises information on a second relation between the first detector signal S₁ and the open port detector signal S_{2;open}.

Embodiment 13: The method according to the preceding embodiment, wherein the second relation is given by a mathematical function h:

$${S}_{2 ; open} = h ( {S}_{1} ) .$$

Embodiment 14: The method according to the preceding embodiment, wherein the mathematic function h comprises at least one function selected from the group consisting of: a linear function; a polynomial function, specifically a polynomial function of degree n=2 or higher; a power function; an exponential function; a power law; a sum of two or more of the previous functions.

Embodiment 15: The method according to any one of the three preceding embodiments, wherein the second relation is given by:

$${S}_{2 ; open} = c * {S}_{1} ,$$

wherein c is a constant, c ∈ [symbol] .

Embodiment 16: The method according to any one of the four preceding embodiments, wherein the method comprises in step III. determining the second relation, specifically determining factor c.

Embodiment 17: The method according to any one of the preceding embodiments, wherein steps I. and II. are performed using at least one multiplexing method selected from the group consisting of: a time multiplexing method; a frequency multiplexing method.

Embodiment 18: A method of determining at least one calibrated optical property of at least one sample, the method comprising:
i. providing the sensing device as defined in embodiment 1;
ii. providing the at least one sample, specifically providing the at least one sample to the sample interface;
iii. illuminating the detector element via the at least one first optical path to obtain at least one first detector signal $1;
iv. illuminating the detector element via the at least one second optical path to obtain at least one second detector signal S₂; and
v. determining the at least one calibrated optical property of the sample by using the first detector signal S₁, the second detector signal S₂ and the at least one item of operation calibration information determined by using the method of calibrating a sensing device according to any of the preceding embodiments.

Embodiment 19: The method according to the preceding embodiment, wherein the calibrated optical property of the sample comprises one or more of an optical absorbance and an optical reflectivity of the sample.

Embodiment 20: The method according to any one of the preceding embodiments referring to a method of determining at least one calibrated optical property of at least one sample, wherein the item of operation calibration information comprises information on a first relation between the first detector signal S₁ and a reference signal of the second optical path S_{2;ref}.

Embodiment 21: The method according to the preceding embodiment, wherein the first relation is given by:

$${S}_{2 ; ref} = b * {S}_{1} ,$$

wherein b is a constant, b ∈ [symbol] .

Embodiment 22: The method according to any one of the preceding embodiments referring to a method of determining at least one calibrated optical property of at least one sample, wherein the item of operation calibration information comprises information on a second relation between the first detector signal S₁ and an open port detector signal S_{2;open}.

Embodiment 23: The method according to the preceding embodiment, wherein the second relation is given by:

$${S}_{2 ; open} = c * {S}_{1} ,$$

wherein c is a constant, c ∈ [symbol] .

Embodiment 24: The method according to embodiments 19 and 21, wherein the calibrated optical property of the sample is an optical reflectivity of the sample Rₛₐₘₚₗₑ, wherein

$${R}_{Sample} = \frac{{S}_{2} - c * {S}_{1}}{b * {S}_{1}} .$$

Embodiment 25: The method according to any one of the preceding embodiments referring to a method of determining at least one calibrated optical property of at least one sample, wherein steps iii, and iv. are performed using at least one multiplexing method selected from the group consisting of: a time multiplexing method; a frequency multiplexing method.

Embodiment 26: The method according to any one of the preceding embodiments referring to a method of determining at least one calibrated optical property of at least one sample, further comprising re-determining the item of operation calibration information.

Embodiment 27: The method according to the preceding embodiment, wherein the sensing device further comprises at least one monitoring device for monitoring at least one operation condition of the sensing device, specifically for monitoring an ambient temperature of the sensing device, wherein the item of operation information is re-determined in case the monitored operation condition deviates from a nominal value by more than a given threshold.

Embodiment 28: The method according to any one of the two preceding embodiments, wherein re-determining the item of operation calibration information comprises performing the method of calibrating a sensing device according to any one of the preceding embodiments referring to a method of calibrating a sensing device.

Embodiment 29: A sensing device comprising
a. at least one detector element configured for generating at least one detector signal in response to an illumination of the detector element by incident light;
b. at least one light source configured for emitting light in at least one optical spectral range;
c. at least one sample interface configured for allowing light from the light source to illuminate at least one sample and configured for allowing light from the sample to propagate, specifically via at least one wavelength-selective element, to the detector element;
d. at least one first optical path, wherein the first optical path is configured for allowing light emitted from the light source to propagate, specifically via the wavelength-selective element, to the detector element without passing the sample interface;
e. at least one second optical path, wherein the second optical path is configured for allowing light emitted from the light source to propagate, specifically via the wave-length-selective element, to the detector element by passing the sample interface at least once; and
f. at least one evaluation unit configured for determining at least one calibrated optical property of the sample by using the method of determining at least one calibrated optical property of at least one sample according to any one of the preceding embodiments referring to a method of determining at least one calibrated optical property of at least one sample.

Embodiment 30: The sensing device according to the preceding embodiment, further comprises-ing at least one wavelength-selective element configured for transferring incident light within at least one selected wavelength range onto the detector element.

Embodiment 31: The sensing device according to any one of the two preceding embodiments, wherein the sensing device further comprises at least one monitoring device for monitoring at least one operation condition of the sensing device, specifically for monitoring an ambient temperature of the sensing device.

Embodiment 32: A computer program for calibrating a sensing device comprising instructions which, when the program is executed by a computer or computer network, cause the com-puter or computer network to perform at least step III. of the method of calibrating a sensing device according to any one of the preceding embodiments referring to a method of calibrating a sensing device.

Embodiment 33: The computer program according to the preceding embodiment, further comprising instructions which, when executed by the computer or computer network, cause the computer or computer network to control performing of steps I. and II. of the method of calibrating a sensing device according to any one of the preceding embodiments referring to a method of calibrating a sensing device.

Embodiment 34: A computer-readable storage medium, specifically a non-transient computer-readable storage medium, comprising instructions which, when the instructions are executed by a computer or computer network, cause the computer or computer network to perform at least step III. of the method of calibrating a sensing device according to any one of the preceding embodiments referring to a method of calibrating a sensing device.

Embodiment 35: The computer-readable storage medium according to the preceding embodiment, further comprising instructions which, when the instructions are executed by the computer or computer network, cause the computer or computer network to control performing of steps I. and II. of the method of calibrating a sensing device according to any one of the preceding embodiments referring to a method of calibrating a sensing device.

Embodiment 36: A computer program for determining at least one calibrated optical property of at least one sample comprising instructions which, when the program is executed by a computer or computer network, cause the computer or computer network to perform at least step v. of the method of determining at least one calibrated optical property of at least one sample according to any one of the preceding embodiments referring to a method of determining at least one calibrated optical property of at least one sample.

Embodiment 37: The computer program according to the preceding embodiment, further comprising instructions which, when the program is executed by a computer or computer network, cause the computer or computer network to control performing steps iii, and iv. of the method of determining at least one calibrated optical property of at least one sample according to any one of the preceding embodiments referring to a method of determining at least one calibrated optical property of at least one sample.

Embodiment 38: The computer program according to any one of the two preceding embodiments, further comprising instructions which, when the program is executed by a com-puter or computer network, cause the computer or computer network to prompt a user to perform steps i. and ii. of the method of determining at least one calibrated optical property of at least one sample according to any one of the preceding embodiments referring to a method of determining at least one calibrated optical property of at least one sample.

Embodiment 39: A computer-readable storage medium, specifically a non-transient computer-readable storage medium, comprising instructions which, when the instructions are executed by a computer or computer network, cause the computer or computer network to perform at least step v. of the method of determining at least one calibrated optical property of at least one sample according to any one of the preceding embodiments referring to a method of determining at least one calibrated optical property of at least one sample.

Embodiment 40: The computer-readable storage medium according to the preceding embodiment, further comprising instructions which, when the instructions are executed by a com-puter or computer network, cause the computer or computer network to control performing steps iii, and iv. of the method of determining at least one calibrated optical property of at least one sample according to any one of the preceding embodiments referring to a method of determining at least one calibrated optical property of at least one sample.

Embodiment 41: The computer-readable storage medium according to any one of the two preceding embodiments, further comprising instructions which, when the instructions are executed by a computer or computer network, cause the computer or computer network to prompt a user to perform steps i. and ii. of the method of determining at least one calibrated optical property of at least one sample according to any one of the preceding embodiments referring to a method of determining at least one calibrated optical property of at least one sample.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not re-stricted by the preferred embodiments. The embodiments are schematically depicted in the Figures. Therein, identical reference numbers in these Figures refer to identical or functionally comparable elements.

In the Figures:

FIGS. 1 to 3 show different embodiments of a sensing device in a schematic view;

FIG. 4 shows a flow chart of an embodiment of a method of calibrating a sensing device; and

FIG. 5 shows a flow chart of an embodiment of a method of determining at least one calibrated optical property of at least one sample.

### DETAILED DESCRIPTION OF THE EMBODIMENTS

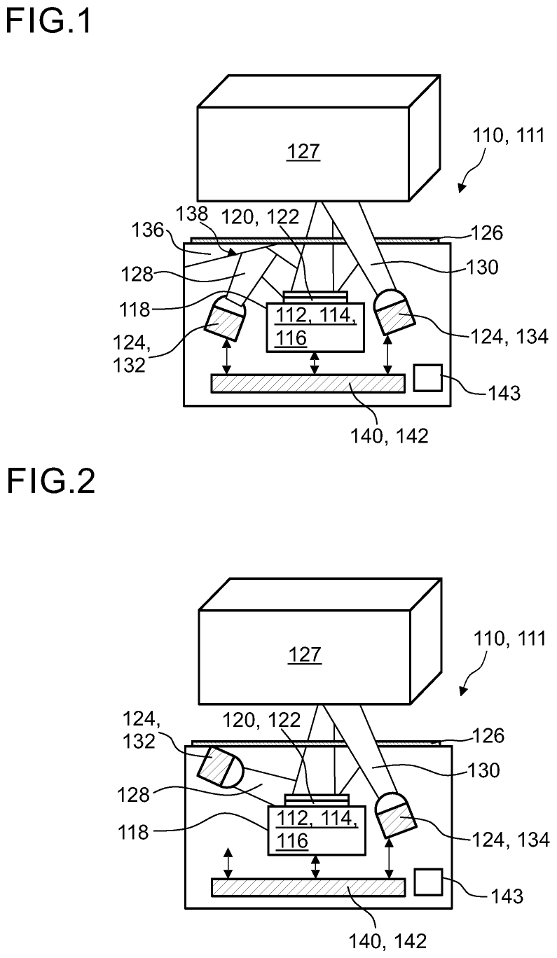

FIG. 1 shows a first exemplary embodiment of a sensing device 110 in a schematic view. In the embodiments of FIGS. 1 to 3, the sensing device 110 may specifically be a spectral sensing device 111. The sensing device 110 comprises at least one detector element 112 configured for generating at least one detector signal in response to an illumination of the detector element 112 by incident light. Specifically, the sensing device 110 may comprise a plurality of detector elements 112 arranged in a detector array 114. Each of the plurality of detector elements 112 may comprise at least one photosensitive element 116 having at least one photosensitive area 118 configured for recording a photoresponse in response to an illumination of the respective detector element 112.

The sensing device 110 may further comprise at least one wavelength-selective element 120 configured for transferring incident light within at least one selected wavelength range onto the detector element 112. For example, the wavelength-selective element 120 may comprise a filter element 122, such as a linear variable filter or an optical filter, specifically a narrow band pass filter. However, other wavelength-selective elements 120, such as prisms or gratings, are also feasible.

The sensing device 110 comprises at least one light source 124 configured for emitting light in at least one optical spectral range. As exemplarily shown in FIG. 1, the sensing device 110 may comprise two light sources 124. The sensing device 110 further comprises at least one sample interface 126 configured for allowing light from the light source 124 to illuminate at least one sample 127 and configured for allowing light from the sample 127 to propagate via the wavelength-selective element 120 to the detector element 112.

The sensing device 110 comprises at least one first optical path 128 and at least one second optical path 130. The first optical path 128 is configured for allowing light emitted from the light source 124 to propagate via the wavelength-selective element 120 to the detector element 112 without passing the sample interface 126. The second optical path 130 is configured for allowing light emitted from the light source 124 to propagate via the wavelength-selective element 120 to the detector element 112 by passing the sample interface 126 at least once.

As outlined above, the sensing device 110 may comprise two light sources 124. In this example, a first light source 132 may be arranged to illuminate the first optical path 128 and a second light source 134 may be arranged to illuminate the second optical path 130. The sensing device 110 may further comprise at least one reflection element 136 in the first optical path 128. The first light source 132 may be arranged to illuminate the reflection element 136. The reflection element 136 may reflect incident light onto the wavelength-selective element 120. The reflection element 136 may comprise at least one reflecting surface 138. The reflecting surface 138 may be one or more of a metallic reflecting surface and a reflecting polymer surface. The reflection at the reflection element 136 may be a specular reflection of light. The reflection at the reflection element 136 may be a broadband reflection, specifically a uniform reflection for multiple wavelengths within at least one range of wavelengths. As can further be seen in FIG. 1, the second light source 134 may be arranged to illuminate the sample interface 126.

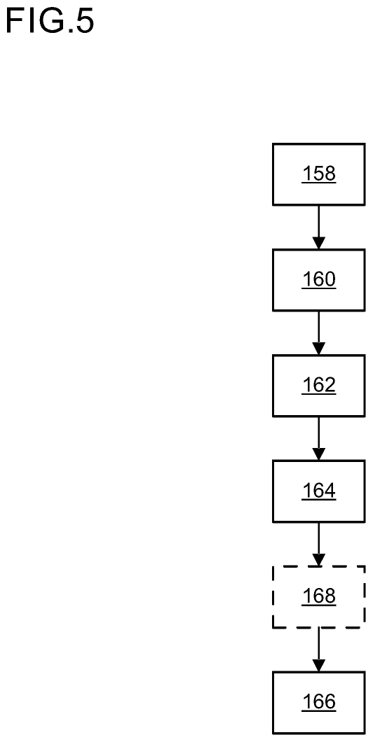

The sensing device 110 further comprises at least one evaluation unit 140. The evaluation unit 140 is configured for determining at least one calibrated optical property of the sample 127 by using the method of determining at least one calibrated optical property of at least one sample 127 according to the present invention, such as according to the exemplary embodiment shown in FIG. 5 and described in further detail below. As shown in FIG. 1, the evaluation unit 140 may be configured for receiving and/or for retrieving detector signals from the detector element 112. The evaluation unit 140 may specifically be configured for evaluating, such as by determining at least one item of operation calibration information and determining the calibrated optical property, the received and/or retrieved detector signals. Specifically, the evaluation unit 140 may comprise one or more processors 142, wherein the one or more processors 142 may be configured, such as by software programming, for performing one or more evaluation operations.

The sensing device 110 may further comprises at least one monitoring device 143 for monitoring at least one operation condition of the sensing device 110, specifically for monitoring one or more of an ambient temperature, a temperature of one or more of the sensing device's 110 components, for example of the light source 124 and/or of the detector element 112, an ambient humidity or the like.

In FIG. 2, a second exemplary embodiment of the sensing device 110 is shown in a schematic view. The embodiment of the sensing device 110 shown in FIG. 2 widely corresponds to the embodiment shown in FIG. 1. Thus, reference is made to the description of FIG. 1. However, as can be seen in FIG. 2, the sensing device 110 may have no reflection element 136. The first light source 132 may be arranged to directly illuminate the wavelength-selective element 120. Thus, in this example, the first light source 132 may directly illuminate the detector element 112 without any other optical components in the first optical path 128.

FIG. 3 shows a third exemplary embodiment of the sensing device 110 in a schematic view. The embodiment of the sensing device 110 shown in FIG. 3 widely corresponds to the embodiment shown in FIG. 1. Thus, reference is made to the description of FIG. 1. In this exemplary embodiment, the sensing device 110 comprises only one light source 124. The light source 124 may specifically be arranged to illuminate the first optical path 128 and the second optical path 130.

As shown in FIG. 3, the sensing device 110 may further comprise at least one first optical modulator 144 arranged in the first optical path 128 configured for modulating light in the first optical path 128 and at least one second optical modulator 146 arranged in the second optical path 130 configured for modulating light in the second optical path 130. The first optical modulator 144 may be configured for modulating light in the first optical path 128 with a first modulation frequency and the second optical modulator 146 may be configured for modulating light with a second modulation frequency. The evaluation unit 140 may be configured for distinguishing detector signals obtained by illumination via the first optical path 128 and the second optical path 130 by distinguishing detector signal associated with the first and the second modulation frequency, respectively. As an example, the first optical modulator 144 and the second optical modulator 146 may comprise a mechanical modulator 148, such as a chopper and/or a slit. However, other optical modulators, such as acousto-optic modulators, electro-optic modulators, spatial light modulators or liquid crystal light modulators may also be feasible.

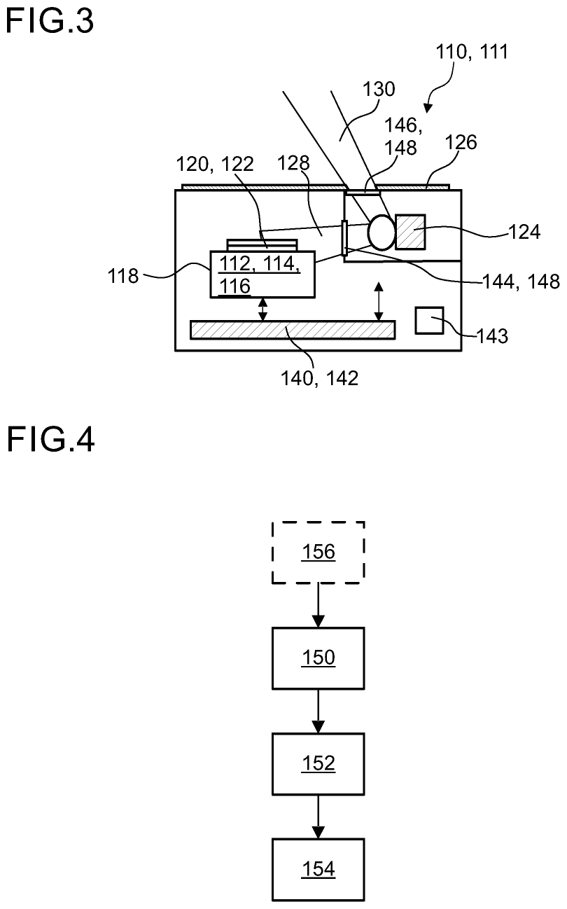

FIG. 4 shows a flow chart of an embodiment of a method of calibrating a sensing device 110. The sensing device 110 to be calibrated in the method may be embodied according to any one of the embodiments shown in FIGS. 1 to 3 and/or according to any other embodiment disclosed herein. Thus, for a description of the sensing device 110, reference is made to the description of FIGS. 1 to 3.

The method comprises the following steps which, as an example, may be performed in the given order. It shall be noted, however, that a different order is also possible. Further, it is also possible to perform one, more than one or even all of the method steps once or repeatedly. Further, it is possible to perform two or more of the method steps simultaneously or in a timely overlapping fashion. The method may comprise further method steps which are not listed.

The method comprises:
I. (denoted by reference number 150) illuminating the detector element 112 via the at least one first optical path 128 to obtain at least one first detector signal S₁;
II. (denoted by reference number 152) illuminating the detector element 112 via the at least one second optical path 130 with no sample 127 applied to the sample interface 126 to obtain at least one open port detector signal S_{2;open}; and
III. (denoted by reference number 154) determining at least one item of operation calibration information by using the first detector signal S₁, the open port detector signal S_{2;open} and at least one item of factory calibration information, wherein the item of factory calibration information comprises a predefined relation between the open port detector signal S_{2;open} and a reference signal of the second optical path 130.

The predefined relation may comprise a linear function S_{2;ref}=a*S_{2;open}, wherein S_{2;ref} denotes the reference signal of the second optical path 130 and wherein a is a constant, a ∈ [symbol] . As shown in FIG. 4, the predefined relation may determined prior to step I., specifically in a factory calibration of the sensing device 110 being performed prior to step I. (denoted by reference number 156).

Further, the item of operation calibration information may comprise information on a first relation between the first detector signal S₁ and the reference signal of the second optical path 130 and a second relation between the first detector signal S₁ and the open port detector signal S_{2;open}. In this exemplary embodiment, both the first relation and the second relation may comprise linear functions, wherein the first relation may be given by S_{2;ref}=b*S₁, wherein b is a constant, b∈ [symbol] , and wherein the second relation may be given by S_{2;open}=c*S₁, wherein c is a constant, c ∈ [symbol] . However, other mathematical functions for the first relation and the second relation, respectively, are also feasible. In this exemplary embodiment, step III. may comprise determining the first relation and the second relation, specifically determining factors b and c.

FIG. 5 shows a flow chart of an embodiment of a method of determining at least one calibrated optical property of at least one sample 127. The sensing device 110 to be used in the method may embodied according to any one of the embodiments shown in FIGS. 1 to 3 and/or according to any other embodiment disclosed herein. Thus, for a description of the sensing device 110, reference is made to the description o FIGS. 1 to 3.

The method comprises the following steps which, as an example, may be performed in the given order. It shall be noted, however, that a different order is also possible. Further, it is also possible to perform one, more than one or even all of the method steps once or repeatedly. Further, it is possible to perform two or more of the method steps simultaneously or in a timely overlapping fashion. The method may comprise further method steps which are not listed.

The method comprises:
i. (denoted by reference number 158) providing the sensing device 110 according to the present invention, such as according to any one of the embodiments described in FIGS. 1 to 3 and/or according to any other embodiment disclosed herein;
ii. (denoted by reference number 160) providing the at least one sample 127, specifically providing the at least one sample 127 to the sample interface 126;
iii. (denoted by reference number 162) illuminating the detector element 112 via the at least one first optical path 128 to obtain at least one first detector signal S₁;
iv. (denoted by reference number 164) illuminating the detector element 112 via the at least one second optical path 130 to obtain at least one second detector signal S₂; and
v. (denoted by reference number 166) determining the at least one calibrated optical property of the sample 127 by using the first detector signal S₁, the second detector signal S₂ and the at least one item of operation calibration information determined by using the method of calibrating a sensing device 110 according to the present invention, such as according to the embodiment shown in FIG. 4 and/or according to any other embodiment disclosed herein.

In this exemplary embodiment, the calibrated optical property of the sample 127 may comprise an optical reflectivity of the sample 127 Rₛₐₘₚₗₑ. As outlined with respect to the exemplary embodiment of FIG. 4, the item of operation calibration information may comprise information on the first relation and on the second relation given by the linear functions S_{2;ref}=b*S₁ and S_{2;open}=c*S₁, respectively. In this example, the optical reflectivity of the sample Rₛₐₘₚₗₑ 127 can be determined in step v. according to:

$${R}_{Sample} = \frac{{S}_{2} - c * {S}_{1}}{b * {S}_{1}} \qquad ( Eq . 11 )$$

The method may further comprise re-determining the item of operation calibration information (denoted by reference number 168). Specifically, in case the sensing device 110 further comprises the monitoring device 143 for monitoring the at least one operation condition of the sensing device 110, the item of operation information may be re-determined in case the monitored operation condition deviates from a nominal value by more than a given threshold. The re-determining the item of operation calibration information may comprise performing the method of calibrating a sensing device 110 according to the present invention, such as according to the exemplary embodiment shown in FIG. 4 and/or according to any other embodiment disclosed herein. As can be seen in FIG. 5, the optional step of re-determining the item of calibration information may be performed prior to step v.

### Example 1

In Example 1, the methods may performed according to the embodiments shown in FIGS. 4 and 5. A factory calibration may be performed at 20° C. and may yield a factor a=10, which is assumed to be constant. During operation of the sensing device at 30° C., a re-calibration of factors b and c by the user may be required. In this example, the sensing device comprises two light sources, wherein the light sources comprise a first LED with a temperature coefficient of −1.1%/K and a second LED with a temperature coefficient of −1.2%/K. Thus, a signal of 1000 counts at 20° C. may decline to S₁=1000 cts*0.89=890 cts and S_{2;open}=1000 cts*0.88=880 cts, respectively. Thus, the reference signal of the second optical path may be:

$${S}_{2 ; ref} = a * {S}_{2 ; open} = 10 * 880 = 8800 cts .$$

Thus, the re-determined factors b and c may be:

$$b = \frac{{S}_{2 ; ref}}{{S}_{1}} = \frac{8800}{890} = 9 \text{.87}$$

$$c = \frac{{S}_{2 ; open}}{{S}_{1}} = \frac{880}{890} = 0.98 .$$

A measurement of a sample with 60% reflectance at 32° C. may be performed as follows:

At 32° C., the responsivity of the detector element will reduce by 4%/K, thus=48% in total. Thus, one would expect signals of in the amount of 0.52 of the initial value at 20° C. Furthermore, the light sources may be drifting with different temperature coefficients of −1.1%/K and −1.2%/K, respectively.

The measured signals at the given temperature are as follows:

$${S}_{1} = 1000 cts * 0.868 * 0.52 \approx 451 cts$$

$${S}_{2 ; measured} = 1 \; 0000 cts * 0.856 * 0.52 * 0.6 + 1000 cts * 0.856 * 0.52 \approx 3116 cts$$

Thus, in this example, the reflectance of the sample may be determined using equation 11:

$${R}_{sample} = \frac{{S}_{2 ; measured} - {S}_{2 ; open}}{{S}_{2 ; ref}} = \frac{( 3116 cts - 451 cts * c )}{451 cts * b} \approx 0.6 .$$

### LIST OF REFERENCE NUMBERS

110 sensing device
111 spectral sensing device
112 detector element
114 detector array
116 photosensitive element
118 photosensitive area
120 wavelength-selective element
122 filter element
124 light source
126 sample interface
127 sample
128 first optical path
130 second optical path
132 first light source
134 second light source
136 reflection element
138 reflecting surface
140 evaluation unit
142 processors
143 monitoring device
144 first optical modulator
146 second optical modulator
148 mechanical modulator
150 illuminating the detector element via the first optical path
152 illuminating the detector element via the second optical path with no sample
154 determining at least one item of operation calibration information
156 factory calibration
158 providing the sensing device
160 providing the sample
162 illuminating the detector element via the first optical path
164 illuminating the detector element via the second optical path
166 determining the calibrated optical property of the sample

1. A method of calibrating a sensing device, the sensing device comprising:
a. at least one detector element configured for generating at least one detector signal in response to an illumination of the detector element by incident light;
b. at least one light source configured for emitting light in at least one optical spectral range;
c. at least one sample interface configured for allowing light from the light source to illuminate at least one sample and configured for allowing light from the sample to propagate to the detector element;
d. at least one first optical path, wherein the first optical path is configured for allowing light emitted from the light source to propagate to the detector element without passing the sample interface; and
e. at least one second optical path, wherein the second optical path is configured for allowing light emitted from the light source to propagate to the detector element by passing the sample interface at least once,
the method comprising:
I. illuminating the detector element via the at least one first optical path to obtain at least one first detector signal S₁;
II. illuminating the detector element via the at least one second optical path with no sample applied to the sample interface to obtain at least one open port detector signal S_{2;open}; and
III. determining at least one item of operation calibration information by using the first detector signal S₁, the open port detector signal S_{2;open} and at least one item of factory calibration information, wherein the item of factory calibration information comprises a predefined relation between the open port detector signal S_{2;open} and a reference signal of the second optical path.

2. The method according to claim 1, wherein the predefined relation is given by a mathematical function ƒ:
$${S}_{2 ; r e f} = f ( {S}_{2 ; o p e n} ) ,$$
wherein S_{2;ref} denotes the reference signal of the second optical path.

3. The method according to claim 2, wherein the predefined relation is given by:
$${S}_{2 ; r e f} = a * {S}_{2 ; o pen} ,$$
wherein a is a constant, a∈ [symbol] .

4. The method according to claim 1, wherein the item of operation calibration information comprises information on a first relation between the first detector signal S₁ and the reference signal of the second optical path, wherein the first relation is given by a mathematical function g:
$${S}_{2 ; r e f} = g ( {S}_{1} ) ,$$
wherein S_{2;ref} denotes the reference signal of the second optical path.

5. The method according to claim 4, wherein the first relation is given by:
$${S}_{2 ; r e f} = b * {S}_{1} ,$$
wherein b is a constant, b∈ [symbol] .

6. The method according to claim 4, wherein the method comprises in step III. determining the first relation, wherein the determining of the first relation comprises using the item of factory calibration information.

7. The method according to claim 1, wherein the item of operation calibration information comprises information on a second relation between the first detector signal S₁ and the open port detector signal S_{2;open}, wherein the second relation is given by a mathematical function h:
$${S}_{2 ; o p e n} = h ( {S}_{1} ) .$$

8. The method according to claim 7, wherein the second relation is given by:
$${S}_{2 ; o p e n} = c * {S}_{1} ,$$
wherein c is a constant, c∈ [symbol] .

9. The method according to claim 7, wherein the method comprises in step III. determining the second relation.

10. A method of determining at least one calibrated optical property of at least one sample, the method comprising:
i. providing the sensing device of claim 1;
ii. providing the at least one sample;
iii. illuminating the detector element via the at least one first optical path to obtain at least one first detector signal S₁;
iv. illuminating the detector element via the at least one second optical path to obtain at least one second detector signal S₂; and
v. determining the at least one calibrated optical property of the sample by using the first detector signal S₁, the second detector signal S₂ and the at least one item of operation calibration information determined by using the method of calibrating a sensing device.

11. The method according to claim 10, wherein the item of operation calibration information comprises information on a first relation between the first detector signal S₁ and a reference signal of the second optical path S_{2;ref}, wherein the first relation is given by:
$${S}_{2 ; r e f} = b * {S}_{1} ,$$
wherein b is a constant, b ∈ [symbol] , wherein the item of operation calibration information comprises information on a second relation between the first detector signal S₁ and an open port detector signal S_{2;open}, wherein the second relation is given by:
$${S}_{2 ; o p e n} = c * {S}_{1} ,$$
wherein c is a constant, c∈ [symbol] , wherein the calibrated optical property of the sample is an optical reflectivity of the sample Rₛₐₘₚₗₑ, wherein
$${R}_{S a m p l e} = \frac{{S}_{2} - c * {S}_{1}}{b * {S}_{1}} .$$

12. The method according to claim 10, further comprising re-determining the item of operation calibration information, wherein the sensing device further comprises at least one monitoring device for monitoring at least one operation condition of the sensing device, wherein the item of operation information is re-determined in case the monitored operation condition deviates from a nominal value by more than a given threshold.

13. The method according to claim 12, wherein re-determining the item of operation calibration information comprises performing the method of calibrating a sensing device.

14. A sensing device comprising
a. at least one detector element configured for generating at least one detector signal in response to an illumination of the detector element by incident light;
b. at least one light source configured for emitting light in at least one optical spectral range;
c. at least one sample interface configured for allowing light from the light source to illuminate at least one sample and configured for allowing light from the sample to propagate to the detector element;
d. at least one first optical path, wherein the first optical path is configured for allowing light emitted from the light source to propagate to the detector element without passing the sample interface;
e. at least one second optical path, wherein the second optical path is configured for allowing light emitted from the light source to propagate to the detector element by passing the sample interface at least once; and
f. at least one evaluation unit configured for determining at least one calibrated optical property of the sample by using the method of determining at least one calibrated optical property of at least one sample according to claim 10.

15. The sensing device according to claim 14, wherein the sensing device further comprises at least one monitoring device for monitoring at least one operation condition of the sensing device.

16. A computer program for calibrating a sensing device comprising instructions, wherein when the program is executed by a computer or computer network, the instructions cause the computer or computer network to perform at least step III. of the method of calibrating a sensing device according to claim 1.

17. A computer program for determining at least one calibrated optical property of at least one sample comprising instructions, wherein when the program is executed by a computer or computer network, the instructions cause the computer or computer network to perform at least step v. of the method of determining at least one calibrated optical property of at least one sample according to claim 10.
